(19) United States
(12) Patent Application Publication
(10) Pub. No.: US 2006/0013987 A1
(43) Pub. Date: Jan. 19, 2006

(54) Optical recording medium

(75) Inventors: Jiro Yoshinari, Tokyo (JP); Hiroshi Shingai, Tokyo (JP); Hideaki Miura, Tokyo (JP); Hiroshi Chihara, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 11/165,218

(22) Filed: Jun. 24, 2005

(30) Foreign Application Priority Data
Jul. 15, 2004 (JP) 2004-208050

(51) Int. Cl. B32B 3/02

(52) U.S. Cl. 428/64.1

(57) ABSTRACT

In an optical recording medium including at least one information layer having a recording film formed of a phase change material mainly containing a binary alloy, the binary alloy is an alloy in which a compound phase or an ordered alloy phase does not appear in a thermal equilibrium phase diagram thereof

### BACKGROUND OF THE INVENTION

The present invention relates to an optical recording medium, and more particularly, to an optical recording medium in which, even if data recorded in a recording film included in an information layer of the optical recording medium is stored at a high temperature for a prolonged period of time, the data can be directly overwritten with new data as desired.

Conventionally, optical recording media represented by compact discs (CD) or digital versatile discs (DVD) have been widely used as recording media for recording digital data.

As a data recording method of the optical recording media, a data recording method has been generally used that data to be recorded is modulated into predetermined lengths of recording marks formed along tracks provided in an optical recording medium. For example, in a DVD-RW that is a kind of optical recording media in which data can be rewritten by a user, recording marks whose lengths correspond to 3T to 11T and 14T where T is one clock period, are used, and data is recorded by forming such recording marks in a recording film included in an information layer along tracks provided in the optical recording medium.

In such a case where the recording marks are formed in the recording film included in the information layer of the data rewritable optical recording medium to record data, a laser beam is irradiated onto the recording film included in the information layer along the tracks provided in the optical recording medium, to change the phase of a phase change material from a crystalline phase contained in the recording film to an amorphous phase, whereby an amorphous region having a predetermined length is formed in the recording film included in the information layer. The amorphous region thus formed is used as a recording mark.

Specifically, when data is recorded in the recording film included in the information layer of the data rewritable optical recording medium, a laser beam whose power is set to a sufficiently high level of a recording power Pw is irradiated onto the recording film included in the information layer to heat and melt a region of the recording film irradiated with the laser beam up to a temperature above the melting point of a phase change material. Next, a laser beam whose power is set to a sufficiently low level of a base power Pb is irradiated onto the recording film included in the information layer, to rapidly cool the melted region of the recording film. As a result, the phase change material included in the region of the recording film is changed from a crystalline phase to an amorphous phase, and recording marks are formed in the recording film included in the information layer, thereby recording data.

On the other hand, when the recording marks formed in the recording film included in the information layer of the data rewritable optical recording medium are erased to erase the data recorded in the recording film, a laser beam whose power is set to an erasing power Pe greater than the base power Pb is irradiated onto the recording film included in the information layer to heat a region of the recording film having a recording mark formed therein up to a temperature above the crystallizing temperature of the phase change material. Next, the heated region of the recording film is gradually cooled. As a result, the phase change material included in the region of the recording film having the recording mark formed therein is changed from an amorphous phase to a crystalline phase to erase the recording mark, thereby erasing data.

Accordingly, by modulating the power of a laser beam to be irradiated onto the recording film included in the information layer of the rewritable optical recording medium between a plurality of levels of power corresponding to the recording power Pw, the base power Pb and the erasing power Pe, it is possible not only to form recording marks in the recording film included in the information layer to record data, but also to form new recording marks while erasing the recording marks already recorded in the recording film to direct overwrite the data already recorded in the recording film with new data.

When the data already recorded in the recording film included in the information layer of the rewritable optical recording medium is directly overwritten with new data, it is preferable to shorten the time required for crystallizing the phase change material in an amorphous phase that forms the recording marks to erase the recording marks. Generally, the recording film included in the information layer of the data rewritable recording medium is formed of a phase change material having a high crystallizing rate (for example, refer to JP-A-10-326436)

Meanwhile, when data is recorded in an optical recording medium having an information layer including a recording film formed of a phase change material, and thereafter the recording medium is stored at a high temperature for a prolonged period of time, it is known that the phase change material which has become amorphous is hardly crystallized (for example, T. Kikukawa, et. al., Jpn. J. Appl. Phys. Vol (41), PP 3020). Accordingly, since it is difficult to erase the recording marks formed in the recording film as desired when data is directly overwritten with new data for the first time after the optical recording medium having data recorded therein is stored at a high temperature for a prolonged period of time, the recording marks which remain without being completely erased and the newly formed recording marks are mixed in the recording film after directly overwritten with new data. As a result, when the newly recorded data is reproduced, there is a problem in that it is difficult to directly overwrite the data recorded in the recording film included in the information layer of the optical recording medium with new data as desired after the optical recording medium is stored at a high temperature for a prolonged period of time because the jitters of reproduced signals degrades.

### SUMMARY OF THE INVENTION

It is therefore an object of the present invention to provide an optical recording medium in which, even if data recorded in a recording film included in an information layer of the optical recording medium is stored at a high temperature for a prolonged period of time, the data can be directly overwritten with new data as desired.

When an optical recording medium having data recorded in its recording film is stored at a high temperature for a prolonged period of time, although the reasons why the phase change material in an amorphous phase is hardly crystallized are not definitely clear, a concept is known that one of the reasons is due to the structural relaxation of recording marks in an amorphous phase (for example, T. Kikukawa, et. al., Jpn. J. Appl. Phys. Vol (41), 2002, PP3020).

Here, ‘the structural relaxation of the recording marks in an amorphous phase’ means that the recording marks in an amorphous phase is changed to a more quasi-stable structure while the amorphous phase is maintained according to the thermal history.

While attention is focused on the above concept, the inventors of the present invention vigorously pursued a study for accomplishing the above object and, as a result, discovered the following facts. That is, in a case where an optical recording medium in which data is recorded in a recording film formed of a phase change material to form recording marks in an amorphous phase is stored at a high temperature, and the structure in an amorphous phase can be changed to a more quasi-stable structure by the above-mentioned structural relaxation of the recording marks, when the structure in an amorphous phase has been changed to a structure in a more quasi-stable compound phase or a structure in an ordered alloy phase or a structure similar thereto, the structure in an amorphous phase changed to such a quasi-stable structure is hardly changed to a crystalline structure even if the phase change material is heated to a temperature above the crystallizing temperature after the change. In contrast, when the structure in an amorphous phase has not been changed to a structure in a more quasi-stable compound phase or a structure in an ordered alloy phase or a structure similar thereto, the structure in an amorphous phase is easily changed to a crystalline structure if the phase change material is heated to a temperature above the crystallizing temperature after the change.

The present inventors further vigorously pursued a study based on such knowledge, and as a result, discovered the following facts. That is, in a case where a binary alloy mainly contained in a phase change material has a compound phase or an ordered alloy change as a quasi-stable phase in a thermal equilibrium phase diagram, when an optical recording medium in which data is recorded in a recording film formed of the phase change material mainly containing the binary alloy to form recording marks in an amorphous phase is stored at a high temperature, the structure in the amorphous phase is easily changed to a compound phase or an ordered alloy phase, or a structure similar thereto. Therefore, when the recorded data is directly overwritten with new data for the first time after the storage of the optical recording medium at a high temperature, it is extremely difficult to reliably erase the recording marks formed in the recording film. Accordingly, it is extremely difficult to prevent degradation of jitters of recorded signals when data is directly overwritten to reproduce the newly recorded data.

In contrast, in a case where a binary alloy does not have a compound phase or an ordered alloy phase as a quasi-stable phase in the thermal equilibrium phase diagram, when an optical recording medium in which data is recorded in a recording film formed of a phase change material mainly containing the binary alloy to form recording marks in an amorphous phase is stored at a high temperature, the structure in the amorphous phase is not changed to a compound phase or an ordered alloy change, or a structure similar thereto by simply being changed to a more quasi-stable structure. Therefore, when the recorded data is directly overwritten with new data for the first time after the storage of the optical recording medium at a high temperature, the recording marks formed in the recording film can be rapidly and reliably erased. Accordingly, it is possible to effectively prevent degradation of jitters of reproduced signals when the data is directly overwritten to reproduce the newly recorded data.

The present invention has been made based on the above knowledge, and according to the present invention, the above object of the present invention can be accomplished by an optical recording medium including at least one information layer having a recording film formed of a phase change material mainly containing a binary alloy, in which the binary alloy is an alloy in which a compound phase or an ordered alloy phase does not appear in a thermal equilibrium phase diagram thereof.

In the present specification, ‘a phase change material mainly containing a binary alloy’ includes a case in which a phase change material contains an alloy in which other element is added to a binary alloy and a case in which a phase change material contains an element other than a binary alloy as well as a case in which a phase change material contains only a binary alloy.

When a structure in an amorphous phase is changed to a structure in a more quasi-stable compound phase or a structure in an ordered alloy phase, or a structure similar thereto by the structural relaxation of recording marks, the structure in the amorphous phase changed to such a more quasi-stable structure is hardly changed to a crystalline structure even if the phase change material is heated to a temperature above the crystallizing temperature thereof after the above change. Although the reasons are not definitely clear, it is considered that this is because an energy barrier which should be overcome when the structure in an amorphous phase when the more quasi-stable stable structure in the amorphous phase thus changed is changed to a crystalline structure when the structure in the amorphous phase has been crystallized is greater than an energy barrier which should be overcome when the structure in the amorphous phase immediately after the recording marks has been formed is changed to a crystalline structure when the structure in the amorphous phase has been crystallized. On the other hand, when a structure in an amorphous phase is not changed to a compound phase or an ordered alloy phase, or a structure similar thereto even if the structure in the amorphous phase is changed to a more quasi-stable structure by the structural relaxation of recording marks, the structure in the amorphous phase is easily changed to a crystalline structure when the phase change material is heated to a temperature above the crystallizing temperature thereof Although the reasons why the structure in the amorphous phase are changed to the crystalline structure are not definitely clear, it is considered that this is because an occasion seldom occurs that an energy barrier which should be overcome when the more quasi-stable structure in the amorphous phase thus changed is changed to a crystalline structure when the structure in the amorphous phase has been crystallized becomes larger than an energy barrier which should be overcome when the structure phase in the amorphous phase immediately after the recording marks have been formed is changed to a crystalline structure when the structure in the amorphous phase has been crystallized.

In the present invention, the binary alloy mainly contained in the phase change material for forming the recording film is not particularly limited so long as it is an alloy in which a compound phase or an ordered alloy phase does not appears in the thermal equilibrium phase diagram. For example, eutectic alloys, peritectic alloys and the like can be used. These binary alloys can be arbitrarily selected from the known binary alloys. Also, these binary alloys are described in, for example, ‘Binary Alloy Phase Diagram Collection’, 2^{nd} Edition, edited by Seizou Nagasaki and Makoto Hirobayashi and published on Jul. 25, 2002 by Agne Gijutu Center.

In the present invention, the binary alloy is preferably a eutectic alloy between single elements, and more preferably a simple eutectic alloy between single elements. In a case where the binary alloy is a simple eutectic alloy between single elements, when data recorded in a recording film formed of a phase change material mainly containing the binary alloy is directly overwritten with new data for the first time after the optical recording medium is stored at a high temperature for a prolonged period of time, it is possible to more effectively prevent degradation of jitters of reproduced signals when the data already recorded is directly overwritten to reproduce the newly recorded data.

In the present invention, ‘an eutectic alloy between single elements’ includes binary alloys having a single eutectic point and binary alloys having two or more eutectic points, in the thermal equilibrium phase diagram, and ‘a simple eutectic alloy between single elements’ indicates binary alloys having a single eutectic point.

In the present invention, one element constituting the binary alloy is more preferably Sb. In a case where one element constituting the binary alloy is Sb, when data recorded in a recording film formed of a phase change material mainly containing the binary alloy is directly overwritten with new data for the first time after the optical recording medium is stored at a high temperature for a prolonged period of time, not only it is possible to effectively prevent degradation of jitters of reproduced signals when the data already recorded is directly overwritten to reproduce the newly recorded data, but also a phase change material mainly containing the binary alloy has a high thermal stability and crystallizing rate, and further has excellent optical characteristics for a laser beam having a wavelength λ of 380 to 450 nm.

In the present invention, the other element constituting the binary alloy is more preferably Ge. In a case where the other element constituting the binary alloy is Ge, when data recorded in a recording film formed of a phase change material mainly containing the binary alloy is directly overwritten with new data for the first time after the optical recording medium is stored at a high temperature for a prolonged period of time, not only it is possible to effectively prevent degradation of jitters of reproduced signals when the data already recorded is directly overwritten to reproduce the newly recorded data, but also a phase change material mainly containing the binary alloy has an extremely high thermal stability and crystallizing rate, and further has excellent optical characteristics for a laser beam having a wavelength λ of 380 nm to 450 nm.

In the present invention, although the binary alloy may contain other one element or two or more elements, when the binary alloy is an Sb—Ge-based binary alloy, it is preferable that the binary alloy does not contain the elements (O, S, Se, Te and Po) of Group 16 in the periodic table.

In the present invention, although the composition of the binary alloy is not particularly limited, when the binary alloy is a eutectic alloy, it preferably has a composition approximate to a eutectic composition, and when the binary alloy is a peritectic alloy, it preferably has a composition approximate to a peritectic composition. For example, in a binary alloy, one element of two elements constituting the binary alloy preferably has a composition in a range of about −12 atomic % to about +4 atomic % with respect to the eutectic composition or the peritectic composition, and more preferably has a composition in a range of about −7 atomic % to about +2 atomic % with respect to the eutectic composition or the peritectic composition.

When the binary alloy is an Sb—Ge binary alloy, since its eutectic composition consists of Sb of about 83 atomic % and Ge of about 17 atomic %, Ge of the binary alloy preferably has a composition in a range of about 5 atomic % to about 21 atomic %, and more preferably has a composition in a range of about 10 atomic % to about 19 atomic %.

Generally, when a recording film formed of a phase change material is thinly formed, it is known that it is difficult to rapidly crystallize a phase change material which has become amorphous (For example, N. Yamada, R. Kojima, et al., Technical Digest of ODS's 2001, p 22, 2001). However, in the present invention, it is possible to effectively prevent degradation of jitters of reproduced signals when data is directly overwritten to reproduce the newly recorded data irrespective of the thickness of the recording film. When the thickness of a recording film is 2 nm to 15 nm, and particularly when the thickness of a recording film is 4 nm to 9 nm, it is possible to more effectively prevent degradation of jitters of reproduced signals when data recorded in the recording film is directly overwritten to reproduce the newly recorded data. Accordingly, in the present invention, the recording film is thinly formed to have a thickness of 2 nm to 15 nm and preferably a thickness of 4 nm to 9 nm.

In such a case where the recording film is thinly formed of a phase change material mainly containing the binary alloy, an information layer including the recording film can be formed to have a high light transmittance for a laser beam. In an optical recoding medium including a plurality of information layers having a recording film formed of a phase change material, when data is recorded in a recording film included in an information layer farthest from a light incidence surface and data is reproduced in the recording film included in the information layer farthest from the light incidence surface, the information layer including the recording film is preferably provided in the optical recording medium as an information layer other than the information layer farthest from the light incidence surface for a laser beam, through which the laser beam passes.

In the present invention, as the binary alloys in which a compound phase or an ordered alloy phase does not appear in the thermal equilibrium diagram there are, for example, eutectic alloys, peritectic alloys and the like. More specifically, the binary alloys include, for example, Ag—Au-based, Ag—Bi-based, Ag—Cu-based, Ag—Ge-based, Ag—Mn-based, Ag—Ni-based, Ag—Pb-based, Ag—Pd-based, Ag—Rh-based, Ag—Si-based, Ag—Tl-based, Al—Be-based, Al—Bi-based, Al—Cd-based, Al—Ga-based, Al—Ge-based, Al—Hg-based, Al—In-based, Al—K-based, Al—Na-based, Al—Pb-based, Al—Si-based, AI—Sn-based, As—Au-based, As—Bi-based, As—Pb-based, As—Sb-based, Au—Co-based, Au—Ge-based, Au—Ni-based, Au—Rh-based, Au—Si-based, Au—Tl-based, Ba—Sr-based, Be—Si-based, Bi—Cd-based, Bi—Cu-based, Bi—Ga-based, Bi—Ge-based, Bi—Hg-based, Bi—Sb-based, Bi—Sn-based, Bi—Zn-based, Ca—Sr-based, Cd—Ga-based, Cd—Ge-based, Cd—Pd-based, Cd—Ti-based, Cd—Zn-based, Ce—La-based, Co—Cu-based, Co—Ni-based, Co—Pd-based, Co—Re-based, Co—Rh-based, Cr—Cu-based, Cr—Mo-based, Cr—U-based, Cr—V-based, Cr—W-based, Cr—Y-based, Cs—K-based, Cs—Rb-based, Cu—Fe-based, Cu—Li-based, Cu—Mn-based, Cu—Nb-based, Cu—Ni-based, Cu—Pb-based, Cu—Rh-based, Cu—Tl-based, Cu—V-based, Fe—La-based, Fe—Mn-based, Fe—Ni-based, Fe—Ru-based, Ga—Ge-based, Ga—Hg-based, Ga—In-based, Ga—Pb-based, Ga—Si-based, Ga—Sn-based, Ga—Ti-based, Ga—Zn-based, Gd—Sc-based, Gd—Y-based, Ge—In-based, Ge—Pb-based, Ge—Sb-based, Ge—Si-based, Ge—Sn-based, Ge—Zn-based, Hf—Nb-based, Hf—Ta-based, Hf—Th-based, Hf—Ti-based, Hf—Zr-based, In—Pb-based, In—Si-based, In—Zn-based, In—Pt-based, Ie—Re-based, Ir—Ru-based, K—Rb-based, Li—Na-based, Mo—Nb-based, Mo—Ta-based, Mo—Th-based, Mo—Ti-based, Mo—V-based, Mo—W-based, Mo—Y-based, Na—Rb-based, Nb—Ta-based, Nb—Ti-based, Nb—U-based, Nb—V-based, Nb—W-based, Nb—Zr-based, Nb—Pr-based, Nd—Sc-based, Ni—Pb-based, Ni—Pd-based, Ni—Re-based, Ni—Rh-based, Ni—Ru-based, Os—Pd-based, Os—Rh-based, Os—Ru-based, Pb—Sb-based, Pb—Si-based, Pb—Sn-based, Pb—Zn-based, Pd—Pt-based, Pd—Rh-based, Pd—Ru-based, Pt—Re-based, Pt—Rh-based, Re—Rh-based, Re—Ru-based, Sc—Ti-based, Sc—Y-based, Sc—Zr-based, Se—Te-based, Si—Zn-based, Sn—Zn-based, Ta—Th-based, Ta—Ti-based, Ta—U-based, Ta—W-based, Ta—Zr-based, Th—Ti-based, Th—U-based, Th—V-based, Th—Y-based, Th—Zr-based, Ti—V-based, Ti—W-based, Ti—Y-based, Ti—Zr-based, Ti—Zn-based, U—V-based, U—W-based, V—W-based, Y—Zr-based, Co—C-based, U—H-based binary alloys and the like.

In the present invention, the simple eutectic alloy between single elements includes, for example, Ag—Bi-based, Ag—Cu-based, Ag—Ge-based, Ag—Pd-based, Ag—Si-based, Ag—Ti-based, Al—Be-based, AI—Ga-based, Al—Ge-based, Al—In-based, Al—Si-based, Al—Sn-based, As—Au-based, As—Bi-based, As—Pb-based, As—Sb-based, Au—Ge-based, Au—Si-based, Au—Tl-based, Be—Si-based, Bi—Cd-based, Bi—Ga-based, Bi—Sn-based, Cd—Pd-based, Cd—Ti-based, Cd—Zn-based, Cr—U-based, Cu—Nb-based, Cu—Ti-based, Fe—La-based, Ga—In-based, Ga—Pb-based, Ga—Sn-based, Ga—Tl-based, Ga—Zn-based, Ge—Sb-based, Ge—Zv-based, In—Zn-based, Li—Na-based, Mo—Th-based, Mo—Y-based, Na—Rb-based, Nb—Zr-based, Ni—Re-based, Pb—Sb-based, Pb—Si-based, Pb—Sn-based, Pd—Ru-based, Sn—Zn-based, Ta—Th-based, Th—Ti-based, Ti—Y-based, Y—Zr-based, Co—C-based binary alloys and the like.

According to the present invention, even if data recorded in a recording film included in an information layer of the optical recording medium is stored at a high temperature for a prolonged period of time, the data can be directly overwritten with new data as desired.

### BRIEF DESCRIPTION OF THE DRAWINGS

FIG. 1 is a partially cutaway perspective view showing an optical recording medium according to a preferred embodiment of the present invention.

FIG. 2 is an enlarged schematic cross-sectional view of a portion of the optical recording medium denoted by A in FIG. 1.

FIG. 3 is an enlarged schematic cross-sectional view of an L0 information layer 20.

FIG. 4 is an enlarged schematic cross-sectional view of an L1 information layer 30.

FIG. 5 is a thermal equilibrium phase diagram of an Sb—Ge-based binary alloy contained in a phase change material which forms an L1 recording film of optical recording medium samples #1 and #2.

FIG. 6 is a thermal equilibrium phase diagram of an Sb—Te-based binary alloy contained in a phase change material which forms an L1 recording film of comparative optical recording medium sample #1.

FIG. 7 is a graph showing initial direct overwrite characteristics, initial direct overwrite characteristics after a high-temperature storage test, and repeated direct overwrite characteristics after the high-temperature storage test, in the optical recording medium sample #1.

FIG. 8 is a graph showing initial direct overwrite characteristics, initial direct overwrite characteristics after a high-temperature storage test, and repeated direct overwrite characteristics after the high-temperature storage test, in the optical recording medium sample #2.

FIG. 9 is a graph showing initial direct overwrite characteristics, initial direct overwrite characteristics after a high-temperature storage test, and repeated direct overwrite characteristics after the high-temperature storage test, in the comparative optical recording medium sample #1.

In the drawings, reference numerals are as follow.

10: OPTICAL RECORDING MEDIUM

11: SUPPORT SUBSTRATE

12: TRANSPARENT INTERMEDIATE LAYER

13: LIGHT TRANSMISSION LAYER

20: L0 INFORMATION LAYER

21, 32: REFLECTIVE FILM

22: SIXTH DIELECTRIC FILM

23: L0 RECORDING FILM

24: FIFTH DIELECTRIC FILM

25,37: HEAT RADIATION FILM

30: L1 INFORMATION LAYER

31: FOURTH DIELECTRIC FILM

33: THIRD DIELECTRIC FILM

34: L1 RECORDING FILM

35: SECOND DIELECTRIC FILM

36: FIRST DIELECTRIC FILM

### DETAILED DESCRIPTION OF THE PREFERRED EMBODIMENTS

Hereinafter, preferred embodiments of the present invention will be described in detail with reference to the accompanying drawings.

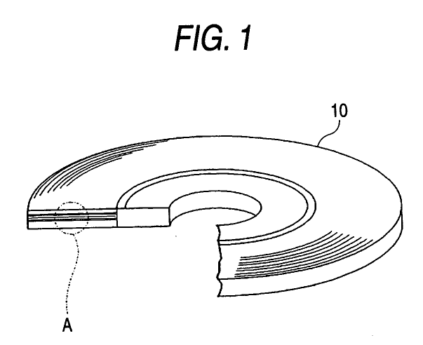

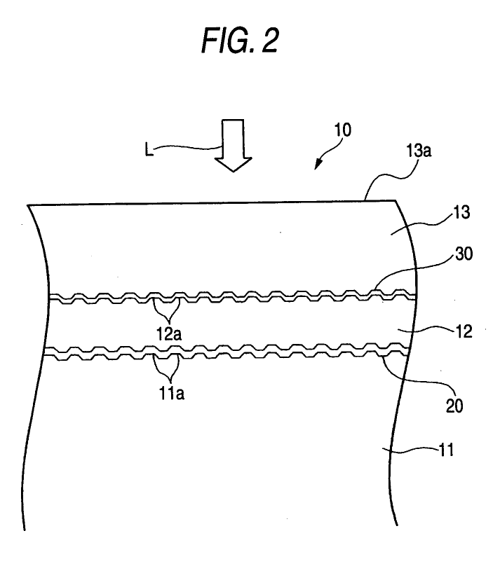

FIG. 1 is a partially cutaway perspective view showing an optical recording medium according to a preferred embodiment of the present invention, and FIG. 2 is an enlarged schematic cross-sectional view of a portion of the optical recording medium denoted by A in FIG. 1.

As shown in FIG. 1, an optical recording medium 10 according to the present embodiment is disk-shaped, and has an outer diameter of about 120 mm and a thickness of about 1.2 mm.

The optical recording medium 10 according to the present embodiment is constituted as a rewritable optical recording medium, and as shown in FIG. 2, includes a support substrate 11, a transparent intermediate layer 12, a light transmission layer 13, an L0 information layer 20 provided between the support substrate 11 and the transparent intermediate layer 12, and an L1 information layer 30 provided between the transparent intermediate layer 12 and the light transmission layer 13. One surface of the light transmission layer 13 constitutes a light incidence surface 13a on which a laser beam L is incident.

In the present embodiment, the L0 information layer 20 constitutes an information layer farther from the light incidence surface 13a, and the L1 information layer 30 constitutes an information layer nearer to the light incidence surface 13a.

In FIG. 2, the optical recording medium 10 according to the present embodiment is constructed such that the laser beam L having a wavelength λ of 380 nm to 450 nm is irradiated onto the light transmission layer 13 via an objective lens (not shown) having a numerical aperture NA, which satisfies λ/NA≦640, from the direction denoted by an arrow L.

The support substrate 11 functions as a support for ensuring mechanical strength required for the optical recording medium 10. The material for forming the support substrate 11 is not particularly limited so long as the support substrate 11 can function as a support for the optical recording medium 10. Preferably, resin is used for forming the support substrate. As such resin, polycarbonate resin and polyolefin resin is particularly preferable from the viewpoint of processability, optical characteristics and the like. In the present embodiment, the support substrate 11 is formed of polycarbonate resin.

In the present embodiment, the support substrate 11 has a thickness of about 1.1 mm.

In the present embodiment, since a laser beam is irradiated via the light transmission layer 13 located opposite to the support substrate 11, the support substrate 11 does not necessarily have a light transmittance property.

As shown in FIG. 2, grooves 11 a are formed on the surface of the support substrate 11. The grooves 11a serve as a guide track for the laser beam L when data is recorded in the L0 information layer 20 or when data is reproduced from the L0 information layer 20.

The support substrate 11 having the grooves 11a on the surface thereof is fabricated by, for example, an injection molding method using a stamper.

The transparent intermediate layer 12 has a function to space the L0 information layer 20 and the L1 information layer 30 apart with a physically and optically sufficient distance.

As shown in FIG. 2, grooves 12a are formed on the surface of the transparent intermediate layer 12. The grooves 12a formed on the surface of the transparent intermediate layer 12 functions as a guide track for the laser beam L when data is recorded in the L1 information layer 30 or when data is reproduced from the L1 information layer 30.

It is necessary for the transparent intermediate layer 12 to have a sufficiently high light transmittance property because the laser beam L passes through the transparent intermediate layer 12 when data is recorded in the L0 information layer 20 or when data is reproduced from the L0 information layer 20. Accordingly, the material for forming the transparent intermediate layer 12 is required to be optically transparent, show low optical absorbance and reflectivity in a wavelength of 380 nm to 450 nm that is the wavelength range of the laser beam L, and have small birefringence. However, the material for forming the transparent intermediate layer 12 is not particularly limited so long as it can meet these conditions. Preferably, the transparent intermediate layer 12 is formed of ultraviolet curable resin such as ultraviolet curable acrylic resin.

The transparent intermediate layer 12 is preferably formed by coating an ultraviolet curable resin solution on the L0 information layer 20 by a spin coating method to form a coating film, and irradiating the surface of the coating film with ultraviolet rays via a stamper formed with the same recess and projection pattern as that of the stamper (not shown) which is used in fabricating the support substrate 11, while covering it with the stamper (not shown).

The light transmission layer 13 is a layer through which the laser beam L is transmitted, and its one surface constitutes the light incidence surface 13a. The material for forming the light transmission layer 13 is required to be optically transparent, show low optical absorbance and reflectivity in a wavelength of 380 nm to 450 nm that is the wavelength range of the laser beam L, and have small birefringence. However, the material for forming the light transmission layer 13 is not particularly limited so long as it can meet these conditions. Preferably, a resin composition containing ultraviolet curable resin, electron beam curable resin, or the like, is used as the material for forming the light transmission layer 13, and more preferably, a resin composition containing ultraviolet curable acrylic resin is used. The light transmission layer 13 is preferably formed to have a thickness of 30 μm to 200 μm.

The light transmission layer 13 is preferably formed by coating a solution of a resin composition on the surface of the L1 information layer 30 by the spin coating method, and the light transmission layer 13 can also be formed by bonding a sheet made of light-transmitting resin to the surface of the L1 information layer 30 with adhesive.

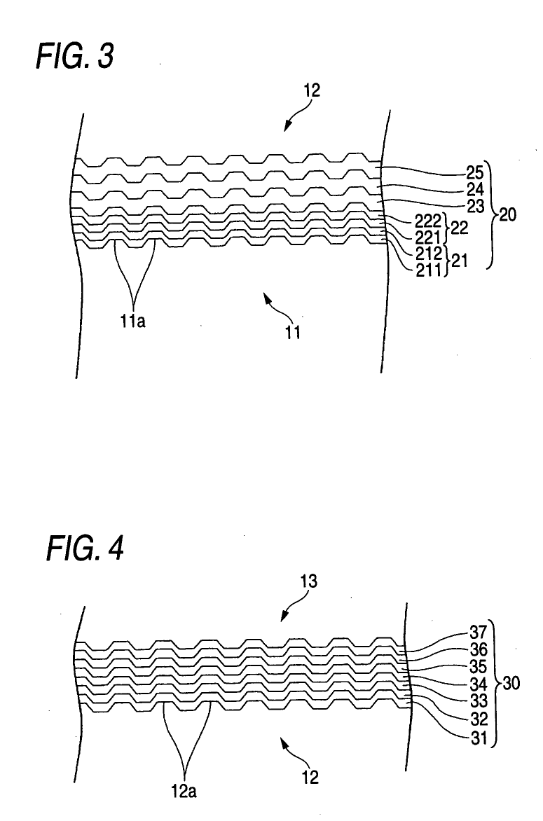

FIG. 3 is an enlarged schematic cross-sectional view of the L0 information layer 20.

As shown in FIG. 3, in the present embodiment, the L0 information layer 20 is constructed such that a reflective film 21, a sixth dielectric film 22, an L0 recording film 23, a fifth dielectric film 24 and a heat radiation film 25 are laminated from the support substrate 11.

The reflective film 21 functions to reflect the laser beam L irradiated onto the L0 recording film 23 via the light transmission layer 13 and the L1 information layer 30 and emit the reflected laser beam from the light transmission layer 13 again, and functions to effectively radiate the heat generated in the L0 recording film 23 caused by the irradiation of the laser beam L. Although the material for forming the reflective film 21 is not particularly limited, Mg, Al, Ti, Cr, Fe, Co, Ni, Cu, Zn, Ge, Ag, Pt, Au, Nd, or the like can be used. Among these, a metallic material such as Al, Au, Ag or Cu, having a high reflectance; alloys of Ag and Cu; or alloy containing at least one of these metals is preferably used for forming the reflective film 21. In particular, when the reflective film 21 contains Ag, the reflective film 21 having an excellent surface smoothness can be formed, so that the noise level of reproduced signals can be lowered, which is preferable.

In the present embodiment, the reflective film 21 is constructed such that a first film 211 and a second film 212 are laminated which are formed of a metallic material containing Ag.

Although the thickness of the reflective film 21 is not particularly limited, it is preferably 10 nm to 300 nm, and more preferably 40 nm to 200 nm.

The reflective film 21 is formed by, for example, the sputtering method.

The sixth dielectric film 22 and the fifth dielectric film 24 has a function to physically and chemically protect the L0 recording film 23, radiate the heat generated in the L0 recording film 23, and increase changes in optical characteristics before and after irradiation of the laser beam L. Although the material for forming the sixth dielectric film 22 and the fifth dielectric film 24 is not particularly limited so long as it is a transparent dielectric material in a wavelength of 380 nm to 450 nm that is the wavelength range of the laser beam L, the sixth dielectric film 22 and the fifth dielectric film 24 are preferably formed of oxides, nitrides, sulfides, carbides, or fluorides which contain at least one kind of metal selected from a group consisting of Si, Zn, Al, Ta, Ti, Co, Zr, Pb, Ag, Sn, Ca, Ce, V, Cu, Fe, and Mg; or complexes thereof.

In the present embodiment, the sixth dielectric film 22 is constructed such that the first film 211 formed of an oxide of Ce and Al and the second film 212 formed of an oxide of Zn and Si are laminated, and the fifth dielectric film 24 is constituted as a single film.

Although the thickness of each of the sixth dielectric film 22 and the fifth dielectric film 24 is not particularly limited, the thickness of the sixth dielectric film 22 is preferably 5 nm to 35 nm, and the thickness of the fifth dielectric film 24 is preferably 10 nm to 80 nm. If the thickness of the sixth dielectric film 22 is less than 5 nm, the recording sensitivity becomes dull, whereas if the thickness of the sixth dielectric film 22 exceeds 35 nm, the heat radiation effect is lowered, which makes it difficult to form sufficiently large marks. If the thickness of the fifth dielectric film 24 is less than 10 nm, the contrast in an amorphous phase and a crystalline phase may be degraded, whereas if the thickness of the fifth dielectric film 24 exceeds 80 nm, the time required for film formation is lengthened, which may lower the productivity of the optical recording medium 10.

The sixth dielectric film 22 and the fifth dielectric film 24 is formed by, for example, the sputtering method.

The L0 recording film 23 is a film for forming recording marks. The L0 recording film 23 is formed of a phase change material, and constituted as a single film. Since the phase change material has different reflective coefficients in a crystalline phase and an amorphous phase, data is recorded and the recorded data is reproduced by using this difference.

Although the phase change material for forming the L0 recording film 23 is not particularly limited, the L0 recording film 23 is preferably formed of a phase change material containing at least a kind of element selected from a group consisting of Sb, Te, Ge, Ag, Tb and Mn. Although the thickness of the L0 recording film 23 is not particularly limited, it is preferably 8 nm to 25 nm.

The L0 recording film 23 is formed by, for example, the sputtering method.

The heat radiation film 25 functions to radiate the heat transferred from the L0 recording film 23 via the fifth dielectric film 24. Although the material for forming the heat radiation film 25 is not particularly limited so long as it has a high light transmittance property with respect for a laser beam, and it can radiate the heat generated in the recording film 23, a material having a higher thermal conductivity than that of the first dielectric film 24 is preferably used, and more specifically, AlN, Al₂O₃, SiN, ZnS, ZnO, SiO₂ or the like is preferably used. The heat radiation film 25 is preferably formed to have a thickness of 10 nm to 120 nm. If the thickness of the heat radiation film 25 is less than 10 nm, a sufficient heat radiation effect may not be obtained, whereas if the thickness of the heat radiation film exceeds 120 nm, a long time is required for forming the heat radiation film 25, which may lower the productivity of the optical recording medium.

The heat radiation film 25 is formed by, for example, the sputtering method.

FIG. 4 is an enlarged schematic cross-sectional view of the L1 information layer 30.

As shown in FIG. 4, in the present embodiment, the L1 information layer 30 is constructed such that a fourth dielectric film 31, a reflective film 32, a third dielectric film 33, an L1 recording film 34, a second dielectric film 35, a first dielectric film 36 and a heat radiation film 37 are laminated from the support substrate 11.

The fourth dielectric film 31 along with the reflective film 32 to be described below functions to effectively radiate the heat generated in the L1 recording film 34 due to irradiation of the laser beam L. Although the material for forming the fourth dielectric film 31 is not particularly limited, oxides, nitrides, sulfides, carbides, or fluorides which contains at least one kind of metal selected from a group consisting of Ti, Zr, Hf, Ta, Si, Al, Mg, Y, Ce and Zn; or complexes thereof can be used. In the present embodiment, the fourth dielectric film 31 contains zirconium oxide with a crystal grain size of 20 nm or less as a main component, and has a cubic crystalline structure. When the fourth dielectric film 31 contains zirconium oxide with a crystal grain size of 20 nm or less as a main component, and has a cubic crystalline structure, the heat generated in the L1 recording film 34 due to irradiation of the laser beam L can be rapidly radiated. The fourth dielectric film 31 is preferably formed to have a thickness of 3 nm to 15 nm. If the thickness of the fourth dielectric film 31 is less than 3 nm, the heat radiation effect is lowered, whereas if the thickness of the fourth dielectric film 31 exceeds 15 nm, an internal stress caused when the fourth dielectric film 31 is formed increases, and thus the fourth dielectric film 31 is likely to be cracked.

The fourth dielectric film 31 is formed by, for example, the sputtering method.

The reflective film 32 serves to effectively reflect the laser beam L irradiated onto the L1 recording film 34 via the light transmission layer 13 and emit the reflected laser beam L from the light transmission layer 13 again, and functions to effectively radiate the heat generated in the L1 recording film 34. Although the material for forming the reflective film 32 is not particularly limited, Mg, Al, Ti, Cr, Fe, Co, Ni, Cu, Zn, Ge, Ag, Pt, Au, Nd, or the like can be used. Among these, a metallic material such as Al, Au, Ag or Cu, having a high reflectance; alloys of Ag and Cu; or alloys containing at least one of these metals is preferably used for forming the reflective film 32. In particular, when the reflective film 32 contains Ag, the reflective film 32 having an excellent surface smoothness can be formed, so that the noise level of reproduced signals can be lowered, which is preferable.

Although the thickness of the reflective film 32 is not particularly limited, it is preferably 5 nm to 25 nm, and more preferably 7 nm to 18 nm.

The third dielectric film 33 along with the second dielectric film 35 serves to physically and chemically protect the L1 recording film 34, and has a function to radiate the heat generated in the L1 recording film 34 caused by the irradiation of the laser beam L to the reflective film 34. Although the material for forming the third dielectric film 33 is not particularly limited, the same material as that for forming the fourth dielectric film 31 can be used. In the present embodiment, similar to the fourth dielectric film 31, the third dielectric film 33 contains zirconium oxide with a crystal grain size of 20 nm or less as a main component, and has a cubic crystalline structure. In this case, the heat generated in the L1 recording film 34 due to irradiation of the laser beam L can be rapidly radiated. The third dielectric film 33 is preferably formed to have a thickness of 3 nm to 15 nm. If the thickness of the third dielectric film 33 is less than 3 nm, it is difficult to form the third dielectric film 33 as a continuous film, whereas if the thickness of the third dielectric film 33 exceeds 15 nm, an internal stress caused when the third dielectric film 33 is formed increases, and thus the third dielectric film 33 is likely to be cracked.

The third dielectric film 33 is formed by, for example, the sputtering method.

The L1 recording film 34 is a film for forming recording marks. The L1 recording film 34 is formed of a phase change material and constituted as a single film. Since the phase change material has different reflective coefficients in a crystalline phase and an amorphous phase, data is recorded and the recorded data is reproduced by using this difference.

In the present invention, the binary alloy mainly contained in a phase change material for forming the L1 recording film 34 is not particularly limited so long as it is a binary alloy in which a compound phase or an ordered alloy phase does not appear in a thermal equilibrium phase diagram thereof For example, a eutectic alloy, a peritectic alloy or the like can be used as the binary alloy. Such a binary alloy can be arbitrarily selected from well-known binary alloys. In a case where the L1 recording film 34 is formed of a phase change material mainly containing such a binary alloy, when data recorded in the L1 recording film 34 is directly overwritten with new data for the first time after the optical recording medium is stored at a high temperature for a prolonged period of time, it is possible to effectively prevent degradation of jitters of reproduced signals when the data is directly overwritten to reproduce the newly recorded data. As a result, even if data recorded in a recording film contained in an information layer of an optical recording medium is stored for a prolonged period of time at a high temperature, the data can be directly overwritten with new data as desired.

In the present invention, the binary alloy in which a compound phase or an ordered alloy phase does not appear in the thermal equilibrium phase diagram is preferably a eutectic alloy between single elements, and more preferably a simple eutectic alloy between single elements. In a case where the binary alloy mainly contained in a phase change material for forming the L1 recording film 34 is a simple eutectic alloy between single elements, when data recorded in the L1 recording film 34 formed of a phase change material mainly containing the binary alloy is directly overwritten with new data for the first time after the optical recording medium is stored at a high temperature for a prolonged period of time, it is possible to more effectively prevent degradation of jitters of reproduced signals when the data already recorded is directly overwritten to reproduce the newly recoded data,

In the present invention, one element constituting the binary alloy is more preferably Sb. In a case where one element of two elements constituting the binary alloy is Sb, not only it is possible to effectively prevent degradation of jitters of reproduced signals when data is directly overwritten newly recorded data is reproduced, but also a phase change material mainly containing the binary alloy has a high thermal stability and crystallizing rate, and further has excellent optical characteristics for a laser beam having a wavelength λ of 380 nm to 450 nm.

In the present invention, the other element constituting the binary alloy is preferably Ge. In a case where the other element of two elements constituting the binary alloy is Ge, not only it is possible to more effectively prevent degradation of jitters of reproduced signals when newly recorded data is reproduced, but also a phase change material mainly containing the binary alloy has an extremely high thermal stability and crystallizing rate and further has excellent optical characteristics for a laser beam having a wavelength λ of 380 nm to 450 nm.

In the present invention, although the composition of the binary alloy is not particularly limited, when the binary alloy is a eutectic alloy, the binary alloy preferably has a composition approximate to a eutectic composition, and when the binary alloy is a peritectic alloy, the binary alloy preferably has a composition approximate to a peritectic composition. For example, as for the composition of the binary alloy, one elements of two elements constituting a binary alloy is preferably in a range of about −12 atomic % to about +4 atomic % with respect to the eutectic composition or the peritectic composition, and more preferably in a range of about −7 atomic % to about +2 atomic % with respect to the eutectic composition or the peritectic composition.

In the present invention, the phase change material may contain an alloy in which at least one or two other elements is added to the binary alloy, and it may contain at least one or two other elements in addition to the binary alloy. However, when the binary alloy is an Sb−Ge based binary alloy, preferably, the phase change material does not contain the elements of Group 16 in the periodic table.

According to the present embodiment, the L1 recording medium 34 is preferably formed of a phase change material which contains Sb of 79 atomic % to 95 atomic %, and Ge of 5 atomic % to 21 atomic % as main components, and which does not contain the elements of Group 16 in the periodic table, and which contains a binary alloy in which a compound phase or an ordered alloy phase does not appear in the thermal equilibrium phase diagram. The L1 recording medium 34 is more preferably formed of a phase change material which contains Sb of 81 atomic % to 90 atomic %, and Ge of 10 atomic % to 19 atomic % as main components, which does not contains the elements of Group 16 in the periodic table, and which contains a binary alloy in which a compound phase or an ordered alloy phase does not appear in the thermal equilibrium phase diagram.

In the present embodiment, in a case where the L1 recording film 34 is formed of a phase change material which mainly contains a binary alloy in which a compound phase or an ordered phase change does not appear in the thermal equilibrium phase diagram, it is possible to effectively prevent degradation of jitters of reproduced signals when data is directly overwritten to reproduce the newly recorded data, irrespective of the thickness of the L1 recording film 34. If the thickness of the L1 recording film 34 is 2 nm to 15 nm, and in particular, if the thickness of the L1 recording film 34 is 4 nm to 9 nm, it is possible to more effectively prevent degradation of jitters of reproduced signals when data is directly overwritten to reproduce the newly recorded data. Accordingly, in the present embodiment, the L1 recording film 34 is thinly formed to have a thickness of 2 nm to 15 nm, and more preferably 4 nm to 9 nm.

Accordingly, in the present embodiment, since the L1 recording film 34 can be formed thinly while degradation of jitters of reproduced signals can be more effectively prevented, an information layer containing the L1 recording film 34 has a high light transmittance for a laser beam L with a wavelength of 380 nm to 450 nm. Therefore, in the optical recording medium 10 according to the present embodiment, the laser beam L can be irradiated onto the L0 recording film 23 included in the L0 information layer 20 via the L1 information layer 30 located nearer to the light incidence surface 13a. As a result, data can be recorded in the L0 recording film 23 included in the L0 information layer 20 as desired, and the data recorded in the L0 recording film 23 included in the L0 information layer 20 can be reproduced as desired.

The L1 recording film 34 can be formed on the surface of the third dielectric film 33 by a gas phase growth method utilizing chemical species containing elements of the L1 recording film 34. The gas phase growth method includes, for example, a vacuum deposition method, a sputtering method, and the like, and the L1 recording film 34 is preferably formed by the sputtering method.

The second dielectric film 35 along with the third dielectric film 33 serves to physically and chemically protect the L1 recording film 34, and has a function to radiate the heat generated in the L1 recording film 34 due to irradiation of the laser beam L to the heat radiation film 37 which will be described below. Although the material for forming the second dielectric film 35 is not particularly, the same material as the material for forming the fourth dielectric film 31 and the third dielectric film 33 can be used. In the present embodiment, the second dielectric film 35, similar to the fourth dielectric film 31 and the third dielectric film 33, contains zirconium oxide with a crystal grain size of 20 nm or less as a main component, and has a cubic crystalline structure. In this case, the heat generated in the L1 recording film 34 due to irradiation of the laser beam L can be rapidly radiated. The second dielectric film 35 is preferably formed to have a thickness of 3 nm to 15 nm. If the thickness of the second dielectric film 35 is less than 3 nm, the heat radiation effect is lowered, whereas if the thickness of the second dielectric film 35 exceeds 15 nm, an internal stress caused when the second dielectric film 35 is formed increases, and thus the second dielectric film 35 is likely to be cracked.

The second dielectric film 35 is formed by, for example, the sputtering method.

The first dielectric film 36 has a function to increase the adhesiveness between the second dielectric film 35 and the heat radiation film 37. Although the material for forming the first dielectric film 36 is not particularly limited so long as it has a high light transmittance property for the laser beam L, and has a high adhesiveness with the second dielectric film 35 and the heat radiation film 37, the first dielectric film 36 is preferably formed of a mixture of ZnS and SiO₂. When the first dielectric film 36 is formed of the mixture of ZnS and SiO₂, the molar ratio ZnS and SiO₂ is preferably 60:40 to 95:5. If the molar ratio of ZnS is less than 60%, the refractive index of the first dielectric film 36 may be lowered and thus the difference between the reflective coefficient of a region of the L1 recording film 34 where recording mark is formed, and the reflective coefficient of a region of the L1 recording film 34 where recording marks are not formed may be lowered, whereas if the molar ratio of ZnS exceeds 95%, it is difficult to form the first dielectric film 36 as a completely transparent film, resulting in a bad effect such as a decrease in signal output.

The first dielectric film 36 is preferably formed to have a thickness of 5 nm to 50 nm. If the thickness of the first dielectric film 36 is less than 5 nm, the heat radiation film 37 is likely to be cracked, whereas if the thickness of the first dielectric film 36 exceeds 50 nm, the heat radiation effect may be lowered.

The first dielectric film 36 is formed by, for example, the sputtering method.

The heat radiation film 37 serves to radiate the heat transferred from the L1 recording film 34 via the first dielectric film 36. Although the material for forming the heat radiation film 37 is not particularly limited so long as it has a high light transmittance property for the laser beam L and it can radiate the heat generated in the L1 recording film 34, a material having a higher thermal conductivity than the thermal conductivity of the first dielectric film 36, specifically, AlN, Al₂O₃, SiN, ZnS, ZnO, SiO₂ or the like is preferably used. The heat radiation film 37 is preferably formed to have a thickness of 20 nm to 70 nm. If the thickness of the heat radiation film 37 is less than 20 nm, a satisfactory heat radiation effect cannot be obtained, whereas if the thickness of the heat radiation film 37 exceeds 70 nm, the productivity of the optical recording medium may be lowered because a long time is required for forming the heat radiation film 37.

The heat radiation film 37 is formed by, for example, the sputtering method.

When data is recorded in the L0 recording film 23 included in the L0 information layer 20 or the L1 recording film 34 included in the L1 information layer 30 in the optical recording medium 10 according to the present embodiment constructed as above, and when the data recorded in the L0 recording film 23 included in the L0 information layer 20 or the L1 recording film 34 included in the L1 information layer 30 is directly overwritten, the laser beam L whose power is modulated among a recording power Pw, an erasing power Pe, and a base power Pb is focused on the L0 recording film 23 included in the L0 information layer 20 or the L1 recording film 34 included in the L1 information layer 30 via the light transmission layer 13.

In order to record data in the L0 recording film 23 included in the L0 information layer 20 or the L1 recording film 34 included in the L1 information layer 30 with a high recording density, the laser beam L having a wavelength of 380 nm to 450 nm is preferably focused on the L0 recording film 23 included in the L0 information layer 20 or the L1 recording film 34 included in the L1 information layer 30 in the recording medium 10 by using an objective lens having a numerical aperture NA of 0.7 or more. More preferably, the numerical aperture satisfies λ/NA<640 nm.

In the present embodiment, the optical recording medium 10 is constructed such that the laser beam L having a wavelength of 405 nm is focused on the L0 recording film 23 included in the L0 information layer 20 or the L1 recording film 34 included in the L1 information layer 30 by using an objective lens (not shown) having a numerical aperture of 0.85.

In forming recording mark in the L1 recording film 34 included in the L1 information layer 30 of the optical recording medium 10 to record the data, first, the laser beam L whose power is set to the recording power Pw is irradiated onto the L1 recording film 34 of the L1 information layer 30 via the light transmission layer 13 while the optical recording medium 10 is rotated. Then, a region of the L1 recording film 34 on which the laser beam L is irradiated is heated and melted to a temperature above the melting point of a phase change material. Next, the laser beam L whose power is set to the base power Pb is irradiated onto the L1 recording film 34 of the L1 information layer 30 via the light transmission layer 13. Then, the melted region of the L1 recording film 34 is rapidly cooled, whereby the phase change material is changed from a crystalline phase to an amorphous phase.

In that way, the recording marks are formed in the L1 recording film 34 of the L1 information layer 30 to record data.

On the other hand, when the recording marks formed in the L1 recording film 34 included in the L1 information layer 30 of the optical recording medium 10 are erased, the laser beam L whose power is set to the erasing power Pe is irradiated onto the region of the L1 recording film 34 of the L1 information layer 30 where the recording mark is formed via the light transmission layer 34. Then, the region of the L1 recording film 34 onto which the laser beam L is irradiated is heated to a temperature above the crystallizing temperature of a phase change material. Next, the laser beam L is put away from the heated region of the L1 recording film 34, whereby the region of the L1 recording film 34 which has been heated to the temperature of the crystallizing temperature of the phase change material is gradually cooled.

As a result, the phase change material is crystallized, and thus the recording marks which have been formed in the region of the L1 recording film 34 where the laser beam L is irradiated are erased.

In the present embodiment, the L1 recording film 34 of the L1 information layer 30 is formed of a phase change material containing a binary alloy which contains, as main components, Sb of 79 atomic % to 95 atomic % and Ge of 5 atomic % to 21 atomic %, and which does not contain the elements of Group 16 in the periodic table. Also, the binary alloy is an alloy in which a compound phase or an ordered alloy phase does not appear in the thermal equilibrium phase diagram. Therefore, even if the L1 recording film 34 is thinly formed to have a thickness of 2 nm to 15 nm, when data is directly overwritten with new data for the first time after recording marks are formed in the L1 recording film 34 included in the L1 information layer 30, and then the recording medium 10 having the data recorded therein is stored at a high temperature for a prolonged period of time, the recording marks formed in the L1 recording film 34 can be rapidly and reliably erased. Accordingly, it is possible to effectively prevent degradation of jitters of reproduced signals when the data is directly overwritten to reproduce the newly recorded data, and it is also possible to improve the reliability of storage of the optical recording medium 10.

On the other hand, in forming recording marks in the L0 recording film 23 included in the L0 information layer 20 of the optical recording medium 10 to record data, first, the laser beam L whose power is set to the recording power Pw is irradiated onto a region of the L0 recording film 23 of the L0 information layer 20 via the light transmission layer 13 and the L1 information layer 30 while the optical recording medium 10 is rotated. Then, the region of the L0 recording film 23 onto which the laser beam L is irradiated is heated and melted to a temperature above the melting point of a phase change material. Next, the laser beam L whose power is set to the base power Pb, is irradiated onto the L0 recording film 23 of the L0 information layer 20 via the light transmission layer 13 and the L1 information layer 30. Then, the melted region of the L0 recording film 23 is rapidly cooled, whereby the phase change material is changed from a crystalline phase to an amorphous phase.

In that way, recording marks are formed in the L0 recording film 23 of the L0 information layer 20 to record data.

In the present embodiment, when data is recorded in the L0 recording film 23 of the L0 information layer 20, the laser beam L is irradiated onto the L0 recording film 23 of the L0 information layer 20 via the L1 information layer 30. However, the L₁ recording film 34 of the L1 information layer 30 is formed of a phase change material containing a binary alloy in which a compound phase or an ordered alloy phase does not appear in the thermal equilibrium phase diagram. Therefore, even if the L1 recording film 34 is thinly formed to have a thickness of 2 nm to 15 nm, when the data recorded in the L1 recording film 34 included in the L1 information layer 30 of the optical recording medium 10 is stored at a high temperature for a prolonged period of time, the data can be directly overwritten with new data as desired. Accordingly, the thickness of the L1 recording film 34 can be decreased. Moreover, the second dielectric film 35, the third dielectric film 33 and the fourth dielectric film 31 of the L1 information layer 30 contains, as a main component, zirconium oxide having a crystal grains size of 20 nm or less, and has a cubic crystalline structure, and the second dielectric film 35, the third dielectric film 33 and the fourth dielectric film 31 of the L1 information layer 30 has a high thermal conductivity. Therefore, the reflective film 32 of the L1 information layer 30 can be formed thinly. Accordingly, it is possible to thinly form the L1 information layer 30, thereby increasing the light transmittance property of the L1 information layer 30 for the laser beam L. Thus, when the laser beam L is transmitted through the L1 information layer 30, the quantity of the laser beam L can be suppressed to the minimum, so that data can be recorded in the L0 recording film 23 of the L0 information layer 20 as desired.

On the other hand, when the recording marks formed in the L0 recording film 23 included in the L0 information layer 20 of the optical recording medium 10 are erased, the laser beam L whose power is set to the erasing power Pe is irradiated onto a region of the L0 recording film 23 of the L0 information layer 20 where the recording marks are formed via the light transmission layer 13 and the L1 information layer 30. Then, the region where the L0 recording film 23 onto which the laser beam L is irradiated is heated to a temperature above the crystallizing temperature of a phase change material. Next, the laser beam L is put away from the heated region of the L0 recording film 23, whereby the region of the L0 recording film 23 heated to a temperature above the crystallizing point of a phase change material is cooled.

As a result, the phase change material is crystallized and thus the recording marks formed in the region of the L0 recording film 23 onto which the laser beam L is irradiated are erased.

In the present embodiment, when the recording marks recorded in the L0 recording film 23 of the L0 information layer 20 are erased, the laser beam L is irradiated onto the L0 recording film 23 of the L0 information layer 20 via the L1 information layer 30. However, similar to the above-described case where data is recorded in the L0 recording film 23 of the L0 information layer 20, when the laser beam L is transmitted through the L1 information layer 30, the quantity of the laser beam L can be suppressed to the minimum, so that the recording marks formed in the L0 recording film 23 of the L0 information layer 20 can be erased as desired.

In contrast, when the data recorded in the L1 recording film 34 included in the L1 information layer 30 of the optical recording medium 10 is reproduced, the laser beam L whose power is set to the reproducing power Pr is focused on the L1 recording film 34 of the L1 information layer 30 via the light transmission layer 13 while the optical recording medium 10 is rotated, and the quantity of the laser beam L reflected by the L1 recording film 34 and the reflective film 32 is then detected.

On the other hand, when the data recorded in the L0 recording film 23 included in the L0 information layer 20 of the optical recording medium 10 is reproduced, the laser beam L whose power is set to the reproducing power Pr is focused on the L0 recording film 23 of the L0 information layer 20 via the light transmission layer 13 and the L1 information layer 30 while the optical recording medium 10 is rotated, and the quantity of the laser beam L reflected by the L0 recording film 23 and the reflective film 21 is then detected.

In the present embodiment, when the data recorded in the L0 recording film 23 of the L0 information layer 20 is reproduced, the laser beam L is irradiated onto the L0 recording film 23 of the L0 information layer 20 via the L1 information layer 30. However, similar to the above-described case where data is recorded in the L0 recording film 23 of the L0 information layer 20, and to the above-described case where the recording marks formed in the L0 recording film 23 of the L0 information layer 20 are erased, when the laser beam L is transmitted through the L1 information layer 30, the quantity of the light beam L can be decreased to the minimum, so that the data recorded in the L0 recording film 23 of the L0 information layer 20 can be reproduced as desired.

### EXAMPLES

Hereinafter, examples will be described for further clarifying effects of the present invention.

### Example 1

An optical recording medium sample #1 is fabricated in the following way.

First, a polycarbonate substrate having grooves formed thereon at a groove pitch of 0.32 μm was fabricated with a thickness of 1.1 mm and a diameter of 120 mm by injection molding.

Next, the polycarbonate substrate was set on a sputtering apparatus. Then, an L0 information layer was formed on the surface on which the grooves are formed by sequentially forming a reflective film consisting of a first film which contains Ag of 98.4 atomic %, Nd of 0.7 atomic %, and Cu and nitrogen of 0.9 atomic %, and has a thickness of 40 nm, and a second film which contains Ag of 98.4 atomic %, Nd of 0.7 atomic %, and Cu of 0.9 atomic % and has a thickness of 60 nm; a sixth dielectric film consisting of a first film which contains a mixture of CeO₂ and Al₂O₃ whose molar ratio is 80:20 and has a thickness of 10 nm, and a second film which contains, as a main component, a mixture of ZnS and SiO₂ whose molar ratio is 50:50, and has a thickness of 10 nm; an L0 recording film which contains, as a main component, a phase change material containing Sb of 77.1 atomic %, Te of 18.7 atomic % and Ge of 4.2 atomic %, and has a thickness of 10 nm; a fifth dielectric film which contains, as a main component, a mixture of ZnS and SiO₂ whose molar ratio is 80:20, and has a thickness of 40 nm; and a heat radiation film which contains, as a main component, aluminum nitride and has a thickness of 30 nm, using the sputtering method.

It is noted in the above L0 information layer that that the second film constituting the reflective film, the first film constituting the sixth dielectric film, the second film constituting the sixth dielectric film, the L0 recording film and the fifth dielectric film were formed in an atmosphere of argon gas by the sputtering method, using targets having compositions corresponding to the respective films.

It is also noted in the L0 information layer that the first film constituting the reflective film and the heat radiation film was formed in an atmosphere of argon gas and nitrogen gas by an reactive sputtering method, using AgNdCu or Al targets.

Next, the polycarbonate substrate having the L0 information layer formed thereon was set on a spin coating apparatus. Then, a solution of ultraviolet curable acrylic resin was coated on the L0 information layer, and then a transparent stamper having grooves formed therein was superimposed on the coated solution. Next, as the solution of ultraviolet curable acrylic resin was spread while the polycarbonate substrate was rotated, the ultraviolet curable acrylic resin was irradiated and cured with ultraviolet rays, thereby forming a transparent intermediate layer having a thickness of 25 μm. Here, the grooves formed in the transparent intermediate layer had a groove pitch of 0.32 μm.

Next, the polycarbonate substrate having the L0 information layer and the transparent intermediate layer formed thereon was set on the sputtering apparatus. Then, an L1 information layer was formed on the surface of the transparent intermediate layer by sequentially forming a fourth dielectric film which contains, as a main component, aluminum oxide, and has a thickness of 5 nm; a reflective film which contains, as a main component, an alloy consisting of Ag of 98 atomic %, Pd of 1 atomic % and Cu of 1 atomic %, and has a thickness of 10 nm; a third dielectric film which contains, as a main component, aluminum oxide, and has a thickness of 4 nm; an L1 recording film which contains a phase change material consisting of a binary alloy of Sb of 84 atomic % and Ge of 16 atomic %, and has a thickness of 7 nm; a second dielectric film which contains, as a main component, aluminum oxide, and has a thickness of 5 nm; a first dielectric film which contains, as a main component, a mixture of ZnS and SiO₂ whose molar ratio is 80:20, and has a thickness of 10 nm; and a heat radiation film which contains, as a main component, aluminum nitride, and has a thickness of 50 nm, by using the sputtering method.

It is noted herein that the second dielectric film, the third dielectric film and the fourth dielectric film were formed in an atmosphere of argon gas by the sputtering method using a ZrO₂ target.

In the second dielectric film, the third dielectric film and the fourth dielectric film constructed as above, their crystalline structure and crystal grain size were respectively analyzed and measured by using an X-ray diffraction apparatus, ‘ATX-G’ (product name), made by Rigaku Denki Co., Ltd. As a result, all the second dielectric film, the third dielectric film, and the fourth dielectric film contained, as a main component, zirconium oxide with a crystal grain size of 20 nm or less, and had a cubic crystalline structure.

The reflective film of the L1 information layer was formed in an atmosphere of argon gas by the reactive sputtering method using an alloy target consisting of Ag of 98 atomic %, Pd of 1 atomic %, and Cu of 1 atomic %.

The L1 recording film was formed in an atmosphere of argon gas by the sputtering method using an Sb—Ge-based binary alloy target.

The first dielectric film was formed in an atmosphere of argon gas by the sputtering method using a target which contains, as a main component, a mixture of ZnS and SiO₂ whose molar ratio is 80:20.

The heat radiation film of the L1 information layer was formed in an atmosphere of argon gas and nitrogen gas by the reactive sputtering method using an Al target.

Next, a solution of ultraviolet curable acrylic resin was coated on the surface of the heat radiation film of the L1 information layer by the spin coating method, thereby forming a coated film. Then, ultraviolet rays were irradiated onto the coated film to cure the ultraviolet curable acrylic resin, thereby forming a light transmission layer having a thickness of 75 μm.

Thereafter, the optical recording medium was subjected to an initializing treatment with an output of 500 mW by using a semiconductor laser having a wavelength of 810 nm, whereby the L0 recording film included in the L0 information layer and the L1 recording film included in the L1 information layer were crystallized.

In that way, the optical recording medium sample #1 was fabricated.

Next, an optical recording medium sample #2 was fabricated in the same manner as the optical recording medium sample #1 except that an L1 recording film which contains a phase change material consisting of a binary alloy of Sb of 89.5 atomic % and Ge of 10.5 atomic % and has a thickness of 7 nm was formed.

Moreover, a comparative optical recording medium sample #1 was fabricated in the same manner as the optical recording medium sample #1 except that an L1 recording film which contains a phase change material consisting of an Sb—Te-based binary alloy of In of 0.8 atomic %, Sb of 71.1 atomic %, Te of 16.4 atomic %, Ge of 5.5 atomic % and Mn of 6.2 atomic % and has a thickness of 7 nm was formed.

Next, the comparative optical recording medium sample #2 was fabricated in the same manner as the optical recording medium sample #1 except that an L1 recording film which contains a phase change material consisting of a binary alloy of Sb of 100 atomic % and has a thickness of 7 nm was formed.

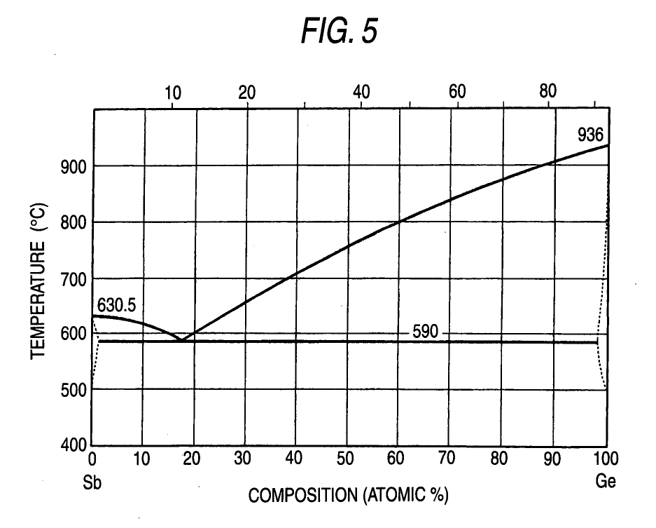

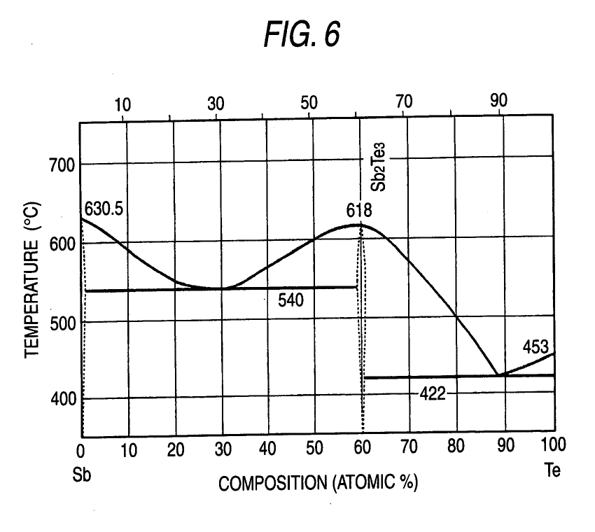

FIG. 5 is a thermal equilibrium phase diagram of an Sb—Ge-based binary alloy contained in a phase change material which forms an L1 recording film of the optical recording medium samples #1 and #2, and FIG. 6 is a thermal equilibrium phase diagram of an Sb—Te-based binary alloy contained in a phase change material which forms an L1 recording film of the comparative optical recording medium sample #1.

As apparent from FIG. 5, the binary alloy contained in a phase change material which forms the L1 recording film of each of the optical recording medium samples #1 and #2 was an Sb—Ge-based binary alloy in which a compound phase or an ordered alloy phase does not appear in the thermal equilibrium phase diagram, and a simple eutectic alloy between single elements. On the other hand, as apparent from FIG. 6, the binary alloy included in a phase change material which forms the L1 recording film of the comparative optical recording medium sample #1 was an Sb—Te-based binary alloy which has a composition of Sb₂Te₃ and in which a compound phase does not appear in the thermal equilibrium phase diagram.

The optical recording medium samples #1 and #2 and the comparative optical recording medium samples #1 and #2 obtained in that way were respectively set on an optical-recording-medium evaluating apparatus, ‘DDU1000’ (product name), made by Pulstec Industrial Co., Ltd. Then, while each of the samples is rotated at a linear velocity of 10.5 m/sec, a laser beam, which has a wavelength of 405 nm in a channel block frequency of 132 MHz and a channel length of 0.12 μm/bit, and has a power modulated according to a predetermined pattern between the recording power Pw and the base power Pb, was irradiated onto the L1 recording film by using an objective lens having a numerical aperture NA of 0.85 via the light transmission layer. Thereby, recording marks having a length of 2T to 8T in 1,7 RLL Modulation Method were randomly combined with each other in the L1 recording film of each of the samples, to record random signals.

Here, when recording marks were formed in the L1 recording film of the optical recording medium sample #1, the recording power Pw of the laser beam was set to 10.2 mW, and the erasing power Pe was set to 3.8 mW; when recording marks were formed in the L1 recording film of the optical recording medium sample #2, the recording power Pw of the laser beam was set to 10.2 mW, and the erasing power Pe was set to 3.4 mW; when recording marks were formed in the L1 recording film of the comparative optical recording medium sample #1, the recording power Pw of the laser beam was set to 10.5 mW, and the erasing power Pe was set to 3.8 mW; and when recording marks were formed in the L1 recording film of the comparative optical recording medium sample #2, the recording power Pw of the laser beam was set to 10.0 mW, and the erasing power Pe was set to 3.4 mW. Further, in all those cases, the base power Pb was set to 0.3 mW and the reproducing power Pr was set to 0.7 mW.

However, in the comparative optical recording medium sample #2, the crystallizing rate of a phase change material included in the L1 recording film was so fast that the phase change material could not be re-crystallized immediately after melting. As a result, it was impossible to form an amorphous region in the L1 recording film to form a recording mark.

Next; the random signals were directly overwritten with new random signals in the same manner as the case in which the random signals are recorded except that a laser beam having its power set to an erasing power (which will be described below) between the recording power Pw and the base power Pb and modulated according to a predetermined pattern was used.

Here, when new random signals were directly overwritten in the L1 recording film of the optical recording medium sample #1, the erasing power Pe of a laser beam was set to 2.6 mW; when new random signals were directly overwritten in the L1 recording film of the optical recording medium sample #2, the erasing power Pe of a laser beam was set to 2.2 mW; and when new random signals were directly overwritten in the L1 recording film of the comparative optical recording medium sample #1, the erasing power Pe of a laser beam was set to 3.0 mW

Next, the optical recording medium samples #1 and #2 and the comparative optical recording medium sample #1 were respectively set on the above-mentioned optical-recording-medium evaluating apparatus. Then, in the same conditions as those in the case in which random signals were recorded, data was directly overwritten to reproduce the recorded random signals, and then the clock jitters (%) of the reproduced signals were measured to evaluate initial direct overwrite characteristics.

It is noted herein that the clock jitters were calculated by σ/Tw (Tw: one clock period) after the fluctuation rate cr of the reproduced signals was obtained using a time interval analyzer.

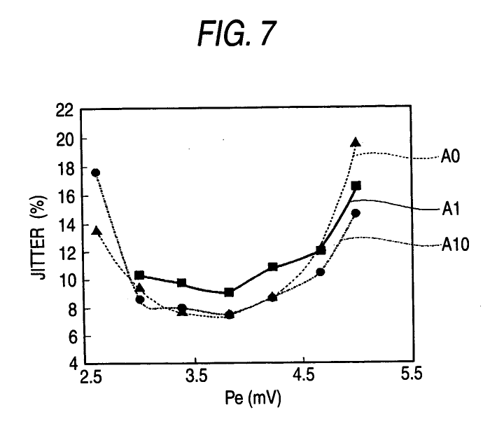

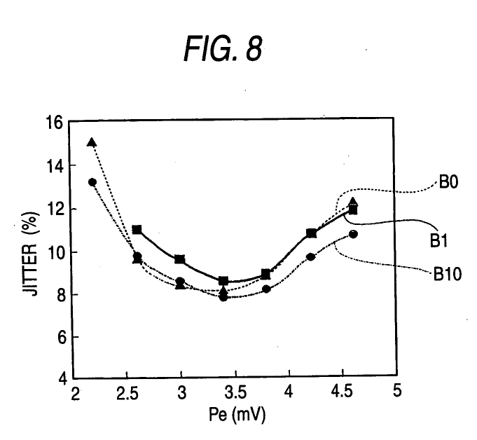

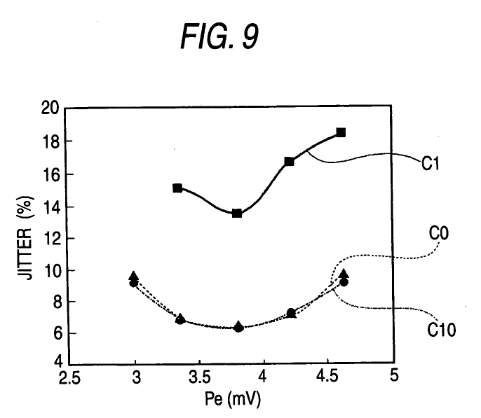

The measurement results for the optical recording medium sample #1 are denoted by a curve A0 in FIG. 7, the measurement results for the optical recording medium sample #2 are dented by a curve B0 in FIG. 8, and the measurement results of the comparative optical recording medium sample #1 are denoted by a curve C0 in FIG. 9.

Moreover, similar to the above method except that the erasing power Pe was sequentially changed by 0.4 mW up to 5.0 mW, the random signals already recorded in the optical recording medium sample #1 were directly overwritten with new random signals to reproduce the newly recorded random signals, and then the clock jitters (%) of the reproduced signals were measured. The measurement results are denoted by the curve A0 in FIG. 7.

Next, similar to the above method except that the erasing power Pe was sequentially changed by 0.4 mW up to 4.6 mW, the random signals already recorded in the optical recording medium sample #2 were directly overwritten with new random signals to reproduce the newly recorded signals, and then the clock jitters (%) of the reproduced signals were measured. The measurement results are denoted by the curve B0 in FIG. 7.

Moreover, similar to the above method except that the erasing power Pe was sequentially changed by 0.4 mW up to 4.6 mW, the random signals already recorded in the comparative optical recording medium sample #1 were directly overwritten with new random signals to reproduce the newly recorded signals, and then the clock jitters (%) of the reproduced signals were measured. The measurement results are denoted by the curve C0 in FIG. 8.

### Example 2

Similar to Example 1, recording marks having a length of 2T to 8T in 1,7 RLL Modulation Method were randomly combined with each other to fabricate the optical recording medium samples #1 and #2 and the comparative optical recording medium sample #1 in which the random signals were recorded. The respective samples were stored at 80° C. under an environment of 10% RH for 24 hours and subjected to a high-temperature storage test.

Next, each of the samples after the high-temperature storage test was set on the above-mentioned optical-recording-medium evaluating apparatus. Then, similar to Example 1, the random signals already recorded in the L1 recording film of each sample were reproduced, and then the clock jitters (%) of the reproduced signals were measured. As a result, it was found that all the samples have almost the same measurement values as those of the clock jitters measured before the high-temperature storage test and thus exhibits high storage reliability.

Next, each of the samples after the high-temperature storage test was set on the above-mentioned optical-recording-medium evaluating apparatus. Then, similar to Example 1, the random signals recorded before the high-temperature storage test were directly overwritten with new random signals one time and repeatedly ten times, the newly recorded random signals were reproduced and then the clock jitters (%) of the reproduced signals were measured. Then, as for each sample, the initial direct overwrite characteristics when the random signals were directly overwritten for the first time after the high-temperature storage test, and the repeated direct overwrite characteristics when the random signals were directly and repeated overwritten after the high-temperature storage test were evaluated.

As for the optical recording medium sample #1, the measurement results of the initial direct overwrite characteristics when random signals were directly overwritten for the first time after the high-temperature storage test are denoted by a curve A1 in FIG. 7; and the measurement results of the repeated direct overwrite characteristics when random signals were directly and repeated overwritten after the high-temperature storage test are denoted by a curve A10 in FIG. 7. As for the optical recording medium sample #2, the measurement results of the initial direct overwrite characteristics when random signals were directly overwritten for the first time after the high-temperature storage test are denoted by a curve B1 in FIG. 8; and the measurement results of the repeated direct overwrite characteristics when random signals were directly and repeatedly overwritten after the high-temperature storage test are denoted by a curve B10 in FIG. 8. As for the comparative optical recording medium sample #1, the measurement results of the initial direct overwrite characteristics when random signals were directly overwritten for the first time after the high-temperature storage test are denoted by a curve C1 in FIG. 9; and the measurement results of the repeated direct overwrite characteristics when random signals were directly and repeatedly overwritten after the high-temperature storage test are denoted by a curve C10 in FIG. 9.

As shown in FIGS. 7, 8 and 9, as for any one of the optical recording medium samples #1 and #2 and the comparative optical recording medium sample #1, it was found that the jitters of the reproduced signals when evaluating the repeated direct overwrite characteristics after the high-temperature storage test have no great difference from the jitters of the reproduced signals when evaluating the initial direct overwrite characteristics.

However, as for the optical recording medium samples #1 and #2, it was observed that the jitters of the reproduced signals when evaluating the initial direct overwrite characteristics after the high-temperature storage test were not remarkably degraded. In contrast, as for the comparative optical recording medium sample #1, it was observed that the jitters were remarkably degraded.

Accordingly, as for the optical recording medium samples #1 and #2 it was found that the data recorded the L1 recording film of each of the samples could be directly overwritten with new data as desired even if the samples were stored at a high temperature for a prolonged period of time. In contrast, the comparative optical recording medium sample #1, it was found that the data recorded in the L1 recording film of the sample could not be directly overwritten with new data as desired when the sample was stored at a high temperature for a prolonged period of time.

Incidentally, similar to Example 1, a laser beam was irradiated onto the L0 recording film of each of the optical recording medium samples #1 and #2 via the light transmission layer and the L1 information layer, then recording marks were formed in the respective L0 recording films to record signals, the recorded signals were reproduced, and further the formed recording marks were erased to erase the recording signals. As a result, as desired, signals could be recorded in the L0 recording film, the signals recorded in the L0 recording film could be reproduced, and the signals recorded in the L0 recording film could be erased.

It should be noted that the present invention is not limited to the above-described embodiments but various changes may be made within the scope of the present invention as set forth in the appended claims and these changes are also included within the scope of the present invention.

For example, the above embodiments have been described with respect to the optical recording medium 10 provided with double information layers including the support substrate 11, the transparent intermediate layer 12, the light transmission layer 13, the L0 information layer 20 provided between the support substrate 11 and the transparent intermediate layer 12, and the L1 information layer 30 provided between the transparent intermediate layer 12 and the light transmission layer 13. However, the present invention is not limited to the optical recording medium having the double information layers, and it can be applied to an optical recording medium having a single information layer and it can be applied to an optical recording medium having two or more information layers. In the case of an optical recording medium having a single information layer, if one information layer includes a recording film formed of a phase change material which mainly contains a binary alloy in which a compound phase or an ordered alloy phase does not appear in the thermal equilibrium phase diagram, the other construction is not particularly limited. For example, the information layer may be constructed such that a reflective film, a second dielectric film, a recording film, a first dielectric film and a heat radiation film are laminated from a support substrate, and the information layer may be constructed such that a fourth dielectric film, a reflective film, a third dielectric film, a recording film, a second dielectric film, a first dielectric film and a heat radiation film are laminated from a support substrate. On the other hand, in the case of an optical recording medium having two or more information layers, it is not necessary that all the information layers other than the L0 information layer 20 includes a recording film formed of a phase change material which mainly contains a binary alloy in which a compound phase or an ordered alloy phase does not appear in the thermal equilibrium phase diagram, and at least one of the information layers other than the L0 information layer 20 farthest from the light incidence surface for a laser beam has only to include a recording film formed of a phase change material which mainly contains a binary alloy in which a compound phase or an ordered alloy phase does not appear in the thermal equilibrium phase diagram. In this case, it is not necessary that all the information layers other than the L0 information layer 20 has a dielectric layer which mainly contains zirconium oxide, and at least one of the information layers other than the L0 information layer 20 has only to include a dielectric film which mainly contains zirconium oxide.

Moreover, the above embodiments have been described with respect to the case where the L0 information layer 20 farther from the light incidence surface of a laser beam is constructed as a rewritable information layer which includes the L0 recording film 23 formed of a phase change material. However, the present invention is not limited, and the L0 information layer 20 may be constituted as a reproducing-only information layer or a write-once information layer. For example, when the L0 information layer 20 is constituted as a reproducing-only information layer, an information layer as the L0 information layer 20 is not particularly provided, and a support substrate or a transparent intermediate layer functions as an information layer farthest from the light incidence surface of a laser beam, and pre-pits are formed on the surface of the support substrate or the transparent intermediate layer, and data is recorded by these pre-pits.

Furthermore, the above embodiments have been described with respect to the case where the optical recording medium 10 is constructed such that it includes the light transmission layer 13, and the laser beam L is irradiated onto the L0 recording film 23 included in the L0 information layer 20 and the L1 recording film 34 included in the L1 information layer 30 via the light transmission layer 13. However, the present invention is not limited to the optical recording medium having such a construction. For example, the optical recording medium may be constructed such that it includes a support substrate formed of a light-transmitting material, and the laser beam L is irradiated onto the L0 recording film 23 included in the L0 information layer 20 and the L1 recording film 34 included in the L1 information layer 30 via the support substrate.

Moreover, the above embodiments have been described with respect to the case where all the second dielectric film 35, the third dielectric film 33 and the fourth dielectric film 31 included in the L1 information layer 30 of the optical recording medium 10 contain, as a main component, zirconium oxide. However, it is not absolutely necessary that all the second dielectric film 35, the third dielectric film 33 and the fourth dielectric film 31 contain, as a main component, zirconium oxide, and at least one of the second dielectric film 35, the third dielectric film 33 and the fourth dielectric film 31 has only to contain, as a main component, zirconium oxide.

Further, the above embodiments have been described with respect to the case where all the third dielectric film 33 and the fourth dielectric film 31 included in the L1 information layer 30 of the optical recording medium 10 are formed adjacent to the reflective film 32. However, it is not absolutely necessary that all the third dielectric film 33 and the fourth dielectric film 31 included in the L1 information layer 30 of the optical recording medium 10 are formed adjacent to the reflective film 32, and other film may be interposed between the third dielectric film 33 and the reflective film 32 and/or between the fourth dielectric film 31 and the reflective film 32 within the range which does not have a great affect on the heat radiation property of the information layer.

Further, the above embodiments have been described with respect to the case where the reflective film 21 of the optical recording medium 10 is constructed such that the first film 211 and the second film 212 are laminated. However, it is not absolutely necessary that the reflective film 21 of the optical recording medium 10 is constructed such that the first film 211 and the second film 212 are laminated, and the reflective film 21 of the optical recording film 10 may be constructed as a single layer or may be constructed such that three or more layers are laminated.

Moreover, the above embodiments have been described with respect to the case where the sixth dielectric film 22 of the optical recording medium 10 is constructed such that the first film 221 and the second film 222 are laminated. However, it is not absolutely necessary that the sixth dielectric film 22 of the optical recording medium 10 is constructed such that the first film 221 and the second film 222 are laminated, and the sixth dielectric film 22 of the optical recording medium 10 may be constructed as a single layer or may be constructed such that three or more layers are laminated.

What is claimed is:

1. An optical recording medium comprising:
at least one information layer including a recording film formed of a phase change material mainly containing a binary alloy,
wherein the binary alloy is an alloy in which a compound phase or an ordered alloy phase does not appear in a thermal equilibrium phase diagram thereof.

2. An optical recording medium according to claim 1, wherein the binary alloy is a simple eutectic alloy between single elements.

3. An optical recording medium according to claim 1, wherein one element constituting the binary alloy is Sb.

4. An optical recording medium according to claim 3, wherein the other element constituting the binary alloy is Ge.

5. An optical recording medium according to claim 2, wherein one element constituting the binary alloy is Sb.

6. An optical recording medium according to claim 5, wherein the other element constituting the binary alloy is Ge.

7. An optical recording medium according to claim 1, wherein the recording film is formed to have a thickness of 2 nm to 15 nm.
